(19) United States
(12) Patent Application Publication
(10) Pub. No.: US 2005/0019474 A1
(43) Pub. Date: Jan. 27, 2005

(54) Coffee products and brews with improved stability

(76) Inventor: Dusan Miljkovic, San Diego, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/897,810

(22) Filed: Jul. 22, 2004

Related U.S. Application Data
(60) Provisional application No. 60/489,766, filed on Jul. 22, 2003.

(51) Int. Cl. A23L 1/00

(52) U.S. Cl. 426/594

(57) ABSTRACT

Stability of a coffee product is increased by combining the coffee product with at least a portion or extract of a coffee cherry, and most preferably of a quick-dried sub-ripe coffee cherry.

This application claims the benefit of U.S. Provisional Patent Application with the Ser. No. 60/489,766, which was filed Jul. 22, 2004.

### FIELD OF THE INVENTION

The field of the invention is compositions and methods for beverages, and particularly those comprising coffee beans.

### BACKGROUND OF THE INVENTION

Despite the apparent safety of oral ingestion of brewed coffee, it is generally known that hydrogen peroxide levels significantly increase in human urine after drinking brewed coffee (see e.g., Free Radic. Res. 32 (2000) 463-467: Coffee drinking increases levels of urinary hydrogen peroxide detected in healthy human volunteers; Long, L. H. and Halliwell, B., or Biol. Pharm. Bull. 25 (2002), 1467-1471: Increased urinary hydrogen peroxide levels caused by coffee drinking; by Hiramoto, K., Kida, T. and Kikugawa, K.). Hydrogen peroxide formation is thought to be facilitated at least in part by roasting byproducts, and especially by quinones or quinone-type compounds. Fortunately, human urine has a remarkable resistance to oxidative stress, predominantly due to the relatively high content in uric acid (see e.g., Clin. Chim. Acta 305, (2001) 167-173; Total urine antioxidant capacity; by Kirschbaum, B.).

However, and especially ex vivo, the formation of hydrogen peroxide is typically not offset by the antioxidative capacity of uric acid. For example, it is well known that taste, aroma, and scent of freshly brewed coffee rapidly deteriorates as the coffee remains on a hot plate. Such deterioration is thought to be precipitated at least in part by the action of radical species (e.g., hydroxyl radical or peroxide radicals). Consequently, brewed coffee is often discarded after a predetermined period of time, or when taste or aroma becomes unacceptable. Alternatively, to at least slow down deterioration of the taste and/or aroma of brewed coffee, the coffee can be stored at lower temperatures (e.g., room temperatures). Such storage tends to increase the time during which coffee flavor can be preserved at somewhat palatable, or partially acceptable levels. However, not everyone enjoys a cup of lukewarm, or even cold coffee.

Therefore, compositions and methods are still need to improve coffee products, and especially to increase storage time of roasted, ground, and/or brewed coffee while preserving taste and/or aroma of the coffee.

### DETAILED DESCRIPTION

The inventors discovered that the stability of roasted coffee beans, grounds made from roasted coffee beans, and brews made from roasted coffee beans can be significantly improved by admixing a coffee cherry preparation (preferably made from sub-ripe coffee cherries, and most preferably made from low-mycotoxin sub-ripe coffee cherries) to the roasted coffee beans, grounds made from roasted coffee beans, and/or brews made from roasted coffee beans.

Based on this discovery, the inventors also contemplate that various ingredients genuine to such coffee cherry preparations (which are typically lost during ripening, roasting, and/or brewing) may be added to roasted coffee beans, grounds made from roasted coffee beans, and brews made from roasted coffee beans to thereby increase storage time of roasted, ground, and/or brewed coffee while preserving taste and/or aroma of the coffee.

As used herein, the term “coffee cherry” refers to the fruit of the coffee tree (Coffea spec., Family Rubiaceae) in which exocarp and outer mesocarp (i.e., the pulp) surround the inner mesocarp (i.e. the mucilage) and endocarp (i.e., the hull), which in turn surround the seeds (i.e., the beans). Thus, the term coffee cherry specifically refers to a whole coffee cherry, which may or may not include the stem of the cherry.

The term “sub-ripe coffee cherry” refers to a coffee cherry that has not yet reached the ripe stage, which is generally characterized by susceptibility to or presence of a fungal infection and/or presence of mycotoxins. Thus, a sub-ripe coffee cherry is at a ripeness stage in which the coffee cherry—when quick-dried—will exhibit mycotoxin levels that are below 20 ppb for total aflatoxins, below 5 ppm for total fumonisins, below 5 ppm for total vomitoxins, and below 5 ppb for ochratoxins. Quick-dried coffee cherries are typically dried within 0-48 hours (and more preferably between 6-24 hours) of the harvest such that the residual water content is no higher than 20% (wt/wt), and more typically no higher than 6-12% (wt/wt).

Viewed from an other perspective, ripe coffee cherries generally have a complete or almost complete (at least 95% of the cherry) red color (or in some cases yellow color), and typically include various surface defects (e.g., blemishes, cuts, and/or holes covering an area of more than 5% of the cherry). Thus, a sub-ripe coffee cherry will typically exhibit at least some green color (at least 5%, more typically at least 10%) and will typically be free of any surface defects (e.g., blemishes, cuts, and/or holes covering an area of less than 5% of the cherry). Sub-ripe coffee cherries may also be characterized in that they will remain on the coffee tree for a subsequent round of picking where the coffee cherries are hand picked and used for the production of coffee beans. Alternatively, a color sorting machine with CCD equipment may be employed to identify and select sub-ripe coffee cherries on a quantitative color basis where the coffee cherries are mass-harvested and automatically sorted.

It should further be appreciated that while many of the following aspects and examples employ coffee cherries in a sub-ripe state, completely ripe coffee cherries are also contemplated suitable herein, especially where such ripe coffee cherries are substantially devoid of surface damage (i.e., no more than 5% of surface area) or microbial infection (i.e., infestation that results in mycotoxin levels of less than 20 ppb for total aflatoxins, less than 5 ppm for total fumonisins, less than 5 ppm for total vomitoxins, and less than 5 ppb for ochratoxins on a dry weight basis). Thus, all products contemplated herein may comprise completely ripe as well as sub-ripe coffee cherries in varying proportions. For example, suitable proportions include 100% ripe: 0% sub-ripe, preferably 90% ripe: 10% sub-ripe, more preferably 75% ripe: 25% sub-ripe, even more preferably 50% ripe: 50% sub-ripe, and most preferably less than 25% ripe: more than 75% sub-ripe.

As also used herein, the term “quick-dried” coffee cherry means that the whole coffee cherry is dried under a protocol that limits growth of molds, fungi, and/or yeast to an extent such that the dried coffee cherry will exhibit mycotoxin levels that are below 20 ppb for total aflatoxins, below 5 ppm for total fumonisins, below 5 ppm for total vomitoxins, and below 5 ppb for ochratoxins. Consequently, quick-dried coffee cherries are typically dried within 0-48 hours (and more preferably between 6-24 hours) of the harvest such that the residual water content is no higher than 20% (wt/wt), and more typically no higher than 6-12% (wt/wt).

It is generally preferred that contemplated coffee cherry preparations will include those described in our co-pending international patent application (serial number PCT/US03/11950), wherein the low-mycotoxin coffee cherry preparations may be prepared using methods described in our co-pending international patent application (serial number PCT/US03/11951), both of which are incorporated by reference herein.

In one exemplary aspect of the inventive subject matter, sub-ripe coffee cherries are visually identified and collected from at semi-ripe stage 1 (typically less than 25% of the coffee cherry is red or yellow) and semi-ripe stage 2 (typically less than 25% of the coffee cherry is green). As much as possible, whole, unbroken and uncut cherries are collected. The so harvested sub-ripe coffee cherries are then washed and dried within less than 12 hours after harvest using an air dryer at 150-160° F. for 16-18 hours to constant weight (equivalent to a residual water content of about 6-12% in the dried cherry). The dried coffee cherries are then ground into a fine powder and admixed to a roasted coffee bean portion, which may or may not be ground to preserved the aroma, scent, and/or flavor. Alternatively, the dried coffee cherries may be extracted with various solvents, and the extract is then added as an ingredient to a beverage, and most preferably a coffee drink. Such combinations are deemed significantly more stable with respect to preservation of aroma, scent, and/or flavor. Additionally, it is contemplated that such combinations may have also increased stability towards microbial growth and/or degradation. Still further, contemplated combinations will exhibit an improved nutrient profile as essential coffee polysaccharides are preserved that otherwise would be destroyed in a roasting process.

While not wishing to be bound by any theory or hypothesis, the inventors contemplate that the protective effect of the low-mycotoxin coffee cherry or portion thereof will be at least in part mediated by the relatively high content in coffee phenolic acids (e.g., chlorogenic acid, ferulic acid, caffeic acid, or other anti-oxidant present in the low-mycotoxin coffee cherry or portion thereof). Therefore, in one aspect of the inventive subject matter, it is thought that admixture of low-mycotoxin coffee cherries or portion thereof may reduce the quantity (or rate of formation) of radicals in brewed coffee and/or in a person that ingests the brewed coffee. In another aspect, the inventors contemplate that the coffee phenolic acids (or other anti-oxidant present in the low-mycotoxin coffee cherry or portion thereof) will increase the time span during which a person will not notice deterioration of flavor, aroma, and/or scent of the brewed coffee stored on a hot plate or other device that keeps the brewed coffee at a desirable temperature. Such protective effect may be due to decreased radical formation (e.g., reduced hydrogen peroxide generation), increased radical scavenging by the low-mycotoxin coffee cherry or portion thereof, and/or other mechanism that decreases oxidation of one or more components in the brewed coffee or grounds of the roasted coffee beans. Furthermore, it should be recognized that contemplated coffee cherry preparations will comprise a substantial quantity of trigonelline and coffee polysaccharides, which are both known to exhibit antiseptic properties (prevent or reduce microbial growth).

Therefore, in one aspect of the inventive subject matter, it is contemplated that taste, aroma, and/or scent of a brewed coffee may be preserved to at least some extent by admixing a low-mycotoxin coffee cherry product to roasted coffee beans, grounds made from roasted coffee beans, and/or brews made from roasted coffee beans. The optimum ratio of low-mycotoxin coffee cherry product to the roasted coffee beans, grounds made from roasted coffee beans, and/or brews made from roasted coffee beans can be easily determined by a person of ordinary skill in the art. However, it is generally preferred that the low-mycotoxin coffee cherry product is present in the admixture in an amount of less than 25 wt %, more preferably less that 15 wt %, and most preferably less than 10 wt %.

Furthermore, it should be recognized that the low-mycotoxin coffee cherry (or portion thereof) is preferably admixed as a whole coffee cherry, a ground preparation, or as an extract of the low-mycotoxin coffee cherry (or portion thereof). However, where appropriate, it is also contemplated that the low-mycotoxin coffee cherry (or portion thereof) can be stored separately from the roasted coffee beans or grounds and then be admixed before, during, or even after the brewing.

### EXAMPLES

The following examples are provided to enable a person of ordinary skill in the art to make and use compositions according to the inventive subject matter and to illustrate exemplary compositions and methods generally described herein.

### Harvest of Whole Coffee Cherries

The ripeness of the coffee cherries was determined by visually estimating the amount of green and red color (or yellow, where applicable) of the whole cherries. As the cherries ripen, the green cherries will typically increase in size and subsequently develop increasing amounts of red color. For the present examples, the coffee cherries were collected at four stages of ripeness: Completely, or almost completely green (unripe; typically less than 5% of the coffee cherry red or yellow), primarily green with some red (semi-ripe, stage 1; typically less than 25% of the coffee cherry red or yellow), primarily red with some green (semi-ripe, stage 2; typically less than 25% of the coffee cherry green), and unbroken, unblemished red (almost ripe; typically less than 10% of the coffee cherry green; area of blemishes, cuts, or otherwise broken surface less than 5%). As much as possible, whole, unbroken and uncut cherries were collected.

### Quick-Drying of the Whole Coffee Cherries

Whole coffee cherries for sample extraction were prepared by drying the cherries within 1-12 hours after harvest on separate trays of an air dryer according to the following procedure. Coffee cherries (400-600 g) were weighed into beakers and washed two times with tap water, followed by a single wash with distilled water. The so washed coffee cherries were placed on a tray of an air dryer to drain, and then dried at 150-160° F. for 16-18 hours to constant weight. Drying was stopped when the weight at two consecutive one-hour intervals differed by less than 1 g. Typical yields of dried whole cherry were 160-220 g. Further analysis indicated 6-12% residual water content in the dried cherry.

### Polyphenol(PP), Chlorogenic Acid (CG), and Caffeine (CF) Analysis for Quick-Dried Sub-Ripe Whole Coffee Cherries

In a further series of experiments, the levels of total polyphenols, chlorogenic acid, and caffeine from quick-dried whole coffee cherry at various sub-ripe stages were measured and compared against green and roasted coffee beans. Table 1 summarizes the results of this analysis.

Interestingly, while the polyphenol (PP) level of quick-dried coffee cherries of all sub-ripe harvest stages was somewhat less than the level of green or roasted coffee beans, significant quantities of polyphenols in quick-dried sub-ripe coffee cherries still remain. Similarly, the chlorogenic acid (CG) content of quick-dried whole coffee cherry at various sub-ripe stages remained at substantial high levels as compared to roasted coffee, but was somewhat lower as compared to green beans. The caffeine (CF) level of quick-dried coffee cherries of all sub-ripe harvest stages was substantially within the caffeine level of green and roasted coffee beans (It should be pointed out that all data given are on a dry matter basis and are not normalized to the dry weight of the bean).

Polyphenol analysis: Dried whole coffee cherry (or green beans or roasted beans) (1.00 g) were ground in a rotating steel knife coffee grinder for 30 seconds to produce a ground sample. The ground sample was added to 100 mL distilled water and the resulting mixture heated to boiling in an Erlenmeyer flask for 30 minutes. The heat was removed and the mixture allowed to cool to room temperature. The resulting suspension was transferred to a 100 mL graduated cylinder and water added to bring the volume to 100 mL. The mixture was then transferred back to the Erlenmeyer flask, stirred briefly, and the solids allowed to settle. An aliquot (˜3 mL) of the supernatant solution was filtered through an 0.45 μm Acrodisc filter, and the resulting clear solution was diluted 1:10 with distilled water using a volumetric flask (1.00 mL diluted with 9.00 mL distilled water).

The Folin-Ciocalteu method was used to measure the polyphenol content of the diluted solution as follows. One mL of the diluted solution was added to a test tube, mixed with 1 mL of 0.2N Folin-Ciocalteu's Phenol reagent (Sigma solution, 2N, diluted 1:10 with water), and allowed to stand 5 minutes at room temperature. One mL of 1N NaHCO₃ was added and the reaction mixture left at room temperature for 2 hours. The polyphenol level was determined using a UV-visible spectrophotometer standardized against catechin, at ?inax=750 nm against distilled water as blank.

Chlorogenic acid: Determination of chlorogenic acid was done using HPLC separation of the filtered clear solution prepared above using standard analytical and separation protocols well known in the art. Similarly, determination of caffeine was done using HPLC separation of the filtered clear solution prepared above using standard analytical and separation protocols well known in the art (for exemplary protocols see e.g., Bispo M. S., et al. in J. Chromatogr. Sci.; 2002, January;40(1):45-8, or Nakakuki, H. et al. in J. Chromatogr. A.;1999, July 2;848(1-2):523-7).

TABLE 1

| RIPENESS | COLOR | % PP | % CG | % CF | CG/CF |
|---|---|---|---|---|---|
| Unripe, quick-dried | Green | 3.80 | 2.64 | 1.03 | 2.56 |
| Semi-ripe stage 1, quick- | Mostly green with | 3.28 | 2.70 | 1.00 | 2.70 |
| dried | some red | | | | |
| Semi-ripe stage 2, quick- | Mostly red with some | 3.54 | 2.00 | 0.70 | 2.86 |
| dried | green | | | | |
| Almost ripe, quick-dried | Red, Blemished Area | 3.35 | N/D | N/D | N/D |
| | <5% | | | | |
| Green Coffee beans | Green | 4.58 | 3.31 | 0.95 | 3.48 |
| Roasted Coffee beans | Brown | 3.93 | 0.50 | 1.20 | 0.42 |

### Polyphenol (PP), Chlorogenic Acid (CG), and Caffeine (CF) Analysis for various Extracts Prepared from Quick-Dried Sub-Ripe Whole Coffee Cherries (I)

The extraction of sub-ripe quick-dried whole coffee cherries of was carried out with various aqueous solvents (100% ethanol, 75:25 (v/v) ethanol/water, 50:50 (v/v) ethanol/water, and water) to determine the polyphenol content of the extracts. Dried whole coffee cherry (10-20 g) was ground in a rotating steel knife coffee grinder for 30 seconds. The ground sample (10.0 g) was added to 100 mL solvent and the mixture boiled with stirring for 90 minutes. Determination of polyphenols, chlorogenic acid, and caffeine were performed substantially as described above. Table 2 summarizes the results.

TABLE 2

| RIPENESS | SOLVENT | % PP | % CG | % CF | CG/CF |
|---|---|---|---|---|---|
| Unripe | 100% Ethanol | 5.84 | 4.96 | 4.46 | 1.11 |
| Unripe | 75:25 Ethanol/ | 13.80 | 12.38 | 4.11 | 3.01 |
| | Water | | | | |
| Unripe | 50:50 Ethanol/ | 14.22 | 14.18 | 4.40 | 3.22 |
| | Water | | | | |
| Unripe | Water | 10.93 | 8.61 | 3.04 | 2.83 |
| Semi-ripe Stage 1 | Water | 9.38 | 7.58 | 2.72 | 2.78 |
| Semi-ripe Stage 2 | Water | 8.51 | 6.74 | 1.71 | 3.95 |
| Almost ripe | Water | 6.92 | 1.34 | 0.29 | 4.61 |
| Semi-ripe Stage 2 | 100% Ethanol | 3.67 | 0.60 | 0.51 | 1.18 |
| Semi-ripe Stage 2 | 75:25 Ethanol/ | 9.80 | 9.14 | 2.59 | 3.53 |
| | Water | | | | |
| Semi-ripe Stage 2 | 50:50 Ethanol/ | 9.55 | 8.79 | 2.59 | 3.40 |
| | Water | | | | |

### Polyphenol (PP), Chlorogenic Acid (CG), and Caffeine (CF) Yield in various Extracts Prepared from Quick-Dried Sub-Ripe Whole Coffee Cherries (II)

Dried coffee cherries (10-20 g) were ground in a rotating steel knife coffee grinder for 30 seconds. The ground sample (10.0 g) was added to 100 mL appropriate solvent and the mixture boiled with stirring for 90 minutes. The mixture was filtered while hot, the filter cake washed twice with the solvent and the filtrate allowed to cool to room temperature. The combined filtrates were rotary evaporated to dryness, using ethanol to remove the final traces of water as an azeotrope. The solid extract was placed in a vacuum desiccator to dry overnight under high vacuum to remove traces of solvent. Table 3 summarizes the results in yield percentages.

TABLE 3

| RIPENESS | SOLVENT | YIELD | % PP | % CF | % CF |
|---|---|---|---|---|---|
| Unripe | 100% Ethanol | 12.6 | 0.74 | 0.62 | 0.56 |
| Unripe | 75:25 Ethanol/ | 22.7 | 3.13 | 2.81 | 0.93 |
| | Water | | | | |
| Unripe | 50:50 Ethanol/ | 20.7 | 2.94 | 2.94 | 0.91 |
| | Water | | | | |
| Unripe | Water | 46.0 | 5.03 | 3.96 | 1.40 |
| Semi-ripe Stage 1 | Water | 53.8 | 5.05 | 4.08 | 1.47 |
| Semi-ripe Stage 2 | Water | 60.5 | 5.15 | 4.08 | 1.03 |
| Almost ripe | Water | 68.7 | 4.75 | 0.92 | 0.20 |
| Semi-ripe Stage 2 | 100% Ethanol | 17.0 | 0.62 | 0.10 | 0.09 |
| Semi-ripe Stage 2 | 75:25 Ethanol/ | 25.3 | 2.48 | 2.31 | 0.65 |
| | Water | | | | |
| Semi-ripe Stage 2 | 50:50 Ethanol/ | 21.5 | 2.05 | 1.89 | 0.56 |
| | Water | | | | |

### Addition of Solid Aqueous Whole Coffee Extracts to Beverages

Solid coffee cherry extract (aqueous) was used to provide level of polyphenols of about 60-70 mg/6 oz., or 10 mg per ounce. About 100 mg of solid unripe (140 mg for almost ripe) aqueous whole coffee cherry extract (provides 10 mg polyphenols) was added to one ounce of beverage and stirred to dissolve. Beverages used were a popular cola, hot coffee, and hot black tea. A panel of 3-4 persons tasted the beverages. Each of the beverages prepared with unripe aqueous coffee cherry extract added possessed flavor almost identical to the original. The beverages prepared with almost ripe aqueous whole coffee cherry extract possessed a definite fruity note in the taste profile.

The unripe (green) whole coffee fruit and aqueous extract possesses the highest polyphenols levels in the dry cherry as well as in the aqueous extracts. Also, as described above, the unripe fruit extracts possess the least flavor and aroma characteristics. Addition of such extracts to existing beverages would be beneficial as it would increase their polyphenols (antioxidant) content yet would not significantly alter or affect the taste and aroma of the beverage. Beverages normally considered to possess minimal health benefit could in this way be made healthier. As an additional benefit, the whole coffee cherry extracts, which normally contain both polyphenols and caffeine could be added to drinks in which caffeine is an ingredient. For example, by adding whole coffee cherry extract to soft drinks (especially colas and similar drinks), one would add caffeine (as a natural caffeine source) as well as polyphenol antioxidants. Manufacturers of such soft drinks could claim the added benefit of polyphenol antioxidants in their caffeinated beverages.

Thus, specific embodiments and applications of coffee products and brews with improved stability have been disclosed. It should be apparent, however, to those skilled in the art that many more modifications besides those already described are possible without departing from the inventive concepts herein. The inventive subject matter, therefore, is not to be restricted except in the spirit of the specification and claims. Moreover, in interpreting the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A combination of a roasted coffee bean and at least a part of a dried coffee cherry.

2. The combination of claim 1 wherein the coffee cherry is quick-dried.

3. The combination of claim 2 wherein the roasted coffee is ground.

4. The combination of claim 3 wherein the coffee cherry is ground.

5. The combination of claim 1, further comprising water.

6. A method of marketing a coffee product, comprising
admixing a roasted coffee bean or portion thereof with at least part of a dried coffee cherry to form a mixture; and
advertising that the mixture has an increased stability towards at least one of oxidation and microbial degradation.

7. The method of claim 6 wherein the roasted coffee bean is ground.

8. The method of claim 6 wherein the dried coffee cherry is ground.

9. The method of claim 6 wherein the dried coffee cherry is sub-ripe and quick dried.

10. The method of claim 6 wherein the increased stability comprises at least one of prolonged aroma, prolonged flavor, and prolonged scent.
